(19) United States
(12) Patent Application Publication
(10) Pub. No.: US 2012/0062934 A1
(43) Pub. Date: Mar. 15, 2012

(54) BENCHMARKING FOR PRINT SERVICE PROVIDERS

(76) Inventors: Eric Hoarau, San Francisco, CA (US); Jun Zeng, Sunnyvale, CA (US); I-Jong Lin, Half Moon Bay, CA (US)

(21) Appl. No.: 12/879,094

(22) Filed: Sep. 10, 2010

(51) Int. Cl. G06F 3/12

(52) U.S. Cl. 358/1.15

(57) ABSTRACT

Benchmarking for a print service provider (PSP) is disclosed. An exemplary method includes receiving a plurality of automatic print service parameters in real-time, and at substantially the same time, receiving a plurality of manual print service parameters. The method also includes deriving performance metrics of the PSP based on based on predictive methods using the automatic and manual print service parameters. The method also includes comparing the derived performance metrics to actual performance at the PSP. The method also includes generating efficiency metrics for automatic and manual print production processes based on the comparison.

### BACKGROUND

Despite the “electronic age,” there is still demand for print services. Print service providers (PSPs) fulfill the demand for print services by printing everything from photographs and brochures, to course materials, periodicals and books. In a modern PSP facility, the management sets targets for average production based on experience and various resource projections. Resources include, but are not limited to, budget considerations (both time and money), equipment (downtime for repairs, cleaning, etc.), and labor (hiring expertise, allotting for planned days off in addition to unplanned sick days, etc.). However, due to the high variability in product and demand, along with the variability of resources in the print industry, these targets are not representative of the actual situation on the floor. Managers typically must “walk the floor” to assess the production process and react to situations on the fly.

Managers also provide feedback to their employees. But this feedback is typically retroactive, based on results from the previous day, week, month, or year. Delayed feedback based on limited data such as this may not be applicable to the current production.

These deviations from real-time operations is particularly acute in the digital printing arts, which are often one-time production jobs and much more susceptible to variable demand and short turn-around times as compared with other manufacturing processes. Other manufacturing processes for example, may order large equipment months or even years in advance, and have single products that can be manufactured for longer cycles (e.g., weeks, or even months, sometimes longer) and can thus be better planned for.

### BRIEF DESCRIPTION OF THE DRAWINGS

FIG. 1 is a block diagram illustrating an exemplary PSP.

FIG. 2 is another block diagram illustrating exemplary workflow at a PSP.

FIG. 3 shows an exemplary layout of a PSP facility.

FIGS. 3a-b show exemplary user interface displays which may be implemented for benchmarking at the PSP shown in FIG. 3, wherein (a) shows workflow for overall plant operations, and (b) shows workflow for a specific station.

FIG. 4 is a flowchart illustrating exemplary operations which may be implemented for benchmarking for a PSP.

### DETAILED DESCRIPTION

Timely print service parameters may be used by a print service provider (PSP) for business strategy, including decisions to expand or consolidate operations such as the purchase of new equipment, hiring/scheduling employees, and various factory operation considerations. By way of illustration, a PSP may use print service parameters to plan production, devise policies, manage production to achieve operations goals or targets (e.g., throughput target, service level target), administer labor force (e.g., hiring, scheduling), and evaluate and give constructive feedback to employees (e.g., administering compensation, bonus calculations).

In addition to the variability in operating parameters (number of employees, experience of the employees, number of machines online, throughput of the machines, etc.), the print process may also vary based on the type of product being produced (e.g., brochures versus books) because of the different efforts required for each (e.g., folding versus binding). The present embodiments integrate digital technologies and an information technology (IT) infrastructure using real-time information to provide dynamic feedback to the user (e.g., individual workers and their managers) based on current operations for setting realistic production targets and benchmarking performance.

In an exemplary embodiment, a plurality of automatic print service parameters are received in real-time, and at substantially the same time as receiving a plurality of manual print service parameters. Performance metrics of the PSP may be derived (e.g., via modeling, simulation, extrapolating from historical records, etc.) based on the automatic and manual print service parameters, and compared to actual performance at the PSP. Efficiency metrics may then be generated for automatic and manual print production processes based on the comparison.

The systems and methods dynamically derive maximum achievable production/capacity based on current factory state and may be used as a benchmark on the floor. Real time visual feedback may be provided on the production floor based on a new benchmark. The visual display may show the data and a graphical floor layout with highlighted information for the workers. Thus, the systems and methods enable workers and managers to quickly and easily understand how they are performing relative to an accurate target, and to understand which resources and where the resources should be allocated. This approach reduces or altogether eliminates the guesswork and reaction delay which is intrinsic to the previous dynamic print production processes.

Accordingly, the embodiments described herein enable holistic system approaches that dynamically optimize print production processes based on the unique combination of equipment, domain expertise, product offerings, business needs, and the addressable market of each PSP. Interfaces and workflow solutions may also be provided that extend beyond the pre-press and press and into the finishing area. Included in this approach, without limitation, is factory scheduling, production planning, workflow management, simulation aided decision-making, optimization, knowledge discovery, and monitoring and tracking.

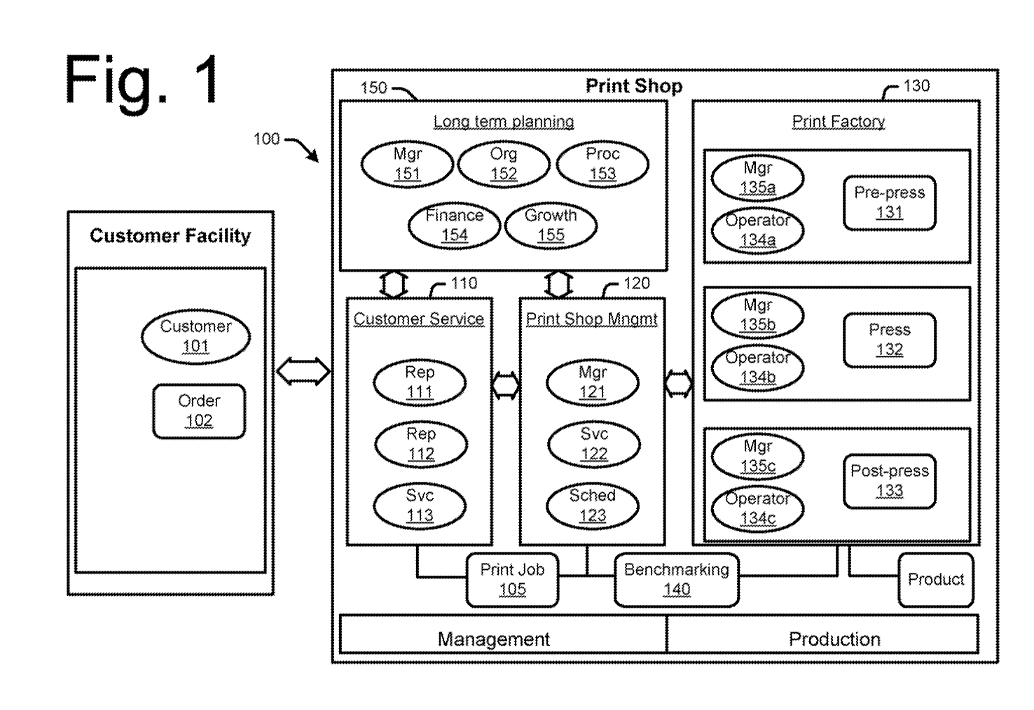

FIG. 1 is a block diagram illustrating an exemplary PSP 100. Also shown in FIG. 1 is a customer 101. The customer 101 may be an individual, a group of individuals, or an organization (non-profit, small business, corporation, and the like).

Although not typically well-suited to an individual, the PSP 100 may function to process print jobs for multiple individuals, such as, the customers of a large retailer, wherein the large retailer takes orders from the individuals (e.g., for photo calendars) and submits the order as a batch of individual customer orders to the PSP 100. In this illustration, the customer 101 is the large retailer submitting the order on behalf of many individuals. Of course the systems and methods described herein are not limited to any particular type or size of customer or customers, and may also be utilized with individual customers 101 of the PSP 100.

In general, the customer 101 creates the material to be printed (e.g., the photographs, brochures, course materials, periodicals, books, advertisements and product packaging) or works with a third-party provider to generate the material to be printed. The customer 101 then submits an order 102 including one or more materials for the PSP 100 to print, along with one or more print parameters (e.g., substrate stock, number of copies, due date, and any special instructions such as laminating and quality level).

The PSP 100 receives and converts the customer's order 102 to a print job 105 as part of customer service 110. A “print job” 105 may include some or all of the print parameters from the order 102, but may also include one or more other parameters, such as prioritizing the print job 105. These priorities may be the same, or different from any priorities specified by the customer 101. For example, meeting the due date may be the same priority for the PSP 100 as for the customer 101. However, the PSP 100 may assign another priority for completing the order 102 prior to the due date, which may be different from one customer 101 to the next (e.g., a repeat and high-volume customer 101 may receive a higher priority from the PSP 100 than a first-time or low-volume customer 101). The print job 105 may also include other parameters assigned by the PSP 100, for example, based on current backlog, supplies in stock, and so forth.

Customer service 110 may also include sales representatives 111, customer service representatives 112, and automatic services 113 that are responsible for advertising and promoting the PSP 100, handling customer complaints, pricing/bidding orders 102, maintaining vendor relations, ordering supplies for the PSP 100, and so forth.

In addition to interfacing with the customer 101, customer service 110 also interfaces with print shop management 120. For example, customer service 110 provides the print job 105 to the print shop management 120 and communicates with the print shop management 120 to ensure that customer expectations are met. Customer service 110 may also assign one or more parameters to the print job 105 based on feedback from the print shop management 120.

Print shop management 120 includes one or more print shop managers 121 and automatic services 122 that are responsible for overseeing operations of the print factory 130, including production scheduling 123. The print shop management 120 is assisted in this regard by benchmarking system 140 and methods disclosed herein and described in more detail below.

Print shop management 120 also communicates with long term planning 150. Long term planning 150 may include management 151 (e.g., executive-level managers) who are responsible for site organization 152, process definition 153, finances 154, and growth strategy 155, among other things.

The print factory 130 may include a number of production operations, including pre-press production 131, press production 132, and post-press production 133. In JDF-enabled workflow, job information and instructions are carried in a JDF format job ticket for digital systems, and file folders for the non-digital part of the production. During pre-press production 131, the print job is converted to the perquisite format (e.g., an electronic bitmap file). During press production 132, the print job is printed on the printing machines. And during post-press production 133, the print job is finished by laminating, cutting, collating, binding, sorting/binning, packaging, and shipping. QA may also be implemented during one or more of the production operations. Each of the production operations may include automatic processes and/or manual processes, and in either case, operators 134a-c and their respective line managers.

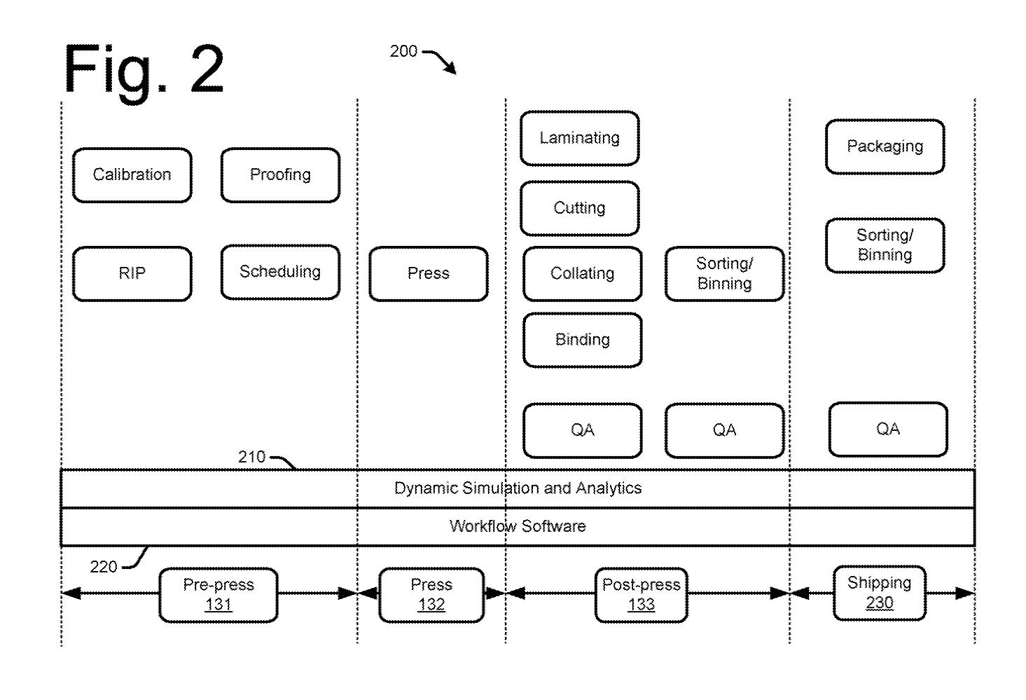

FIG. 2 is another block diagram illustrating exemplary PSP operations 200. The pre-press, press, post-press, and shipping operations have already been discussed above for the respective components of the PSP facility shown in FIG. 1, and therefore the description of these is not repeated here. FIG. 2 show the analytics 210 which may be integrated with workflow software 220 for implementation across the various production operations 131-133 up to and including shipping 230 to provide an overview how and where the benchmarking system and methods described herein may be implemented. It is noted that the analytics 210 can be used for a sub-system or for the full end-to-end system.

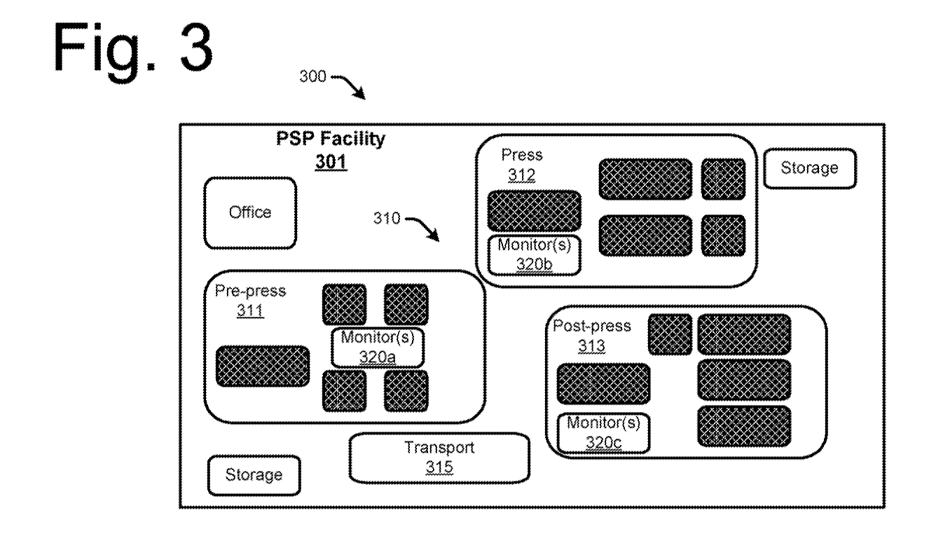

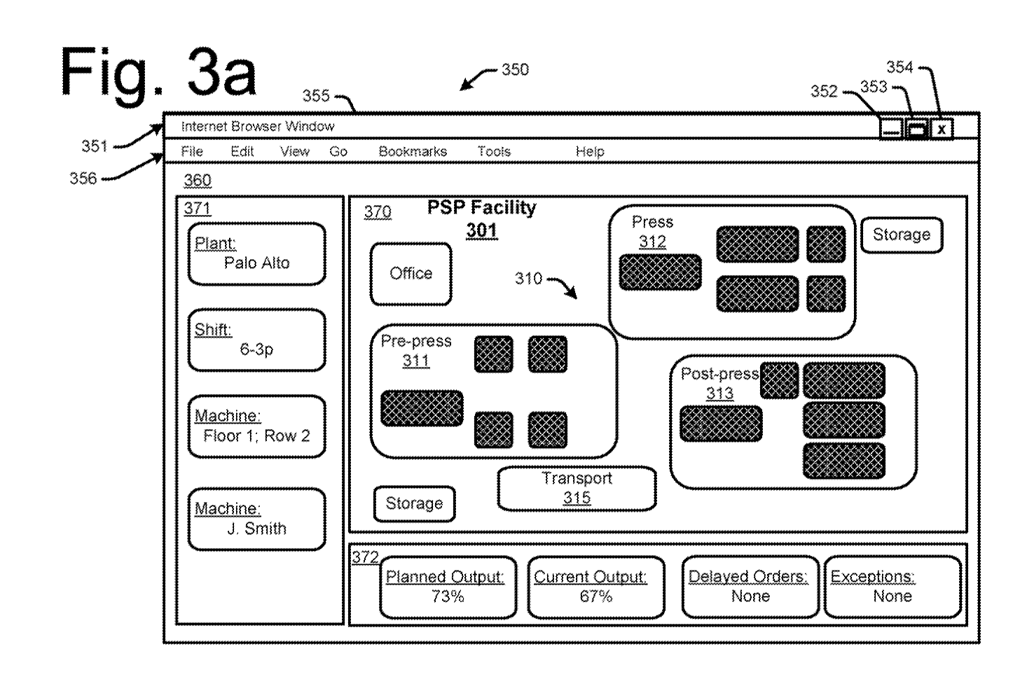

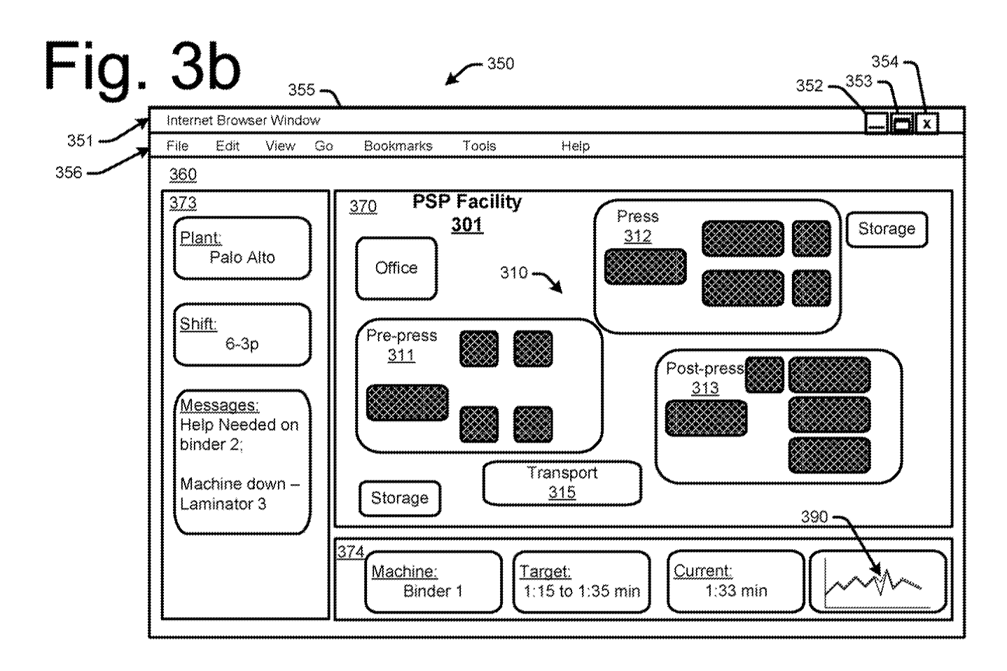

FIG. 3 shows an exemplary layout 300 of a PSP facility 301. The PSP facility 301 may include office space and storage. The PSP facility 301 also includes a number of stations 310, including one or more pre-press station 311, press station 312, and post-press stations 313, as well as transport 315 between the stations (e.g., conveyors or manual delivery routes).

The stations 310 may include one or more workflow monitors 320a-c. In one embodiment, these workflow monitors 320 are automatic and include electronic (e.g., infrared (IR), radio frequency identification (RFID), or barcode scanning) sensors, mechanical counters, or the like. In another embodiment, the workflow monitors 320 include input by a user. Of course information may be obtained for any station that is of interest using a combination of automatic and manually obtained information may be used.

In addition to information from production, information may also be obtained from the print shop management, long term planning, and may include real-time and/or historical data. Information may also be obtained from incoming and outgoing print jobs. Information may be obtained for one or more PSP facility 301.

The information is aggregated via a suitable networked computer system. The networked computer system may include one or more communication networks, such as a local area network (LAN) and/or wide area network (WAN), and may be wireless (e.g., Wi-Fi). A host may be implemented in the networked computer system. Host may include one or more computing systems, such as a server with computer-readable storage. Host may execute a benchmarking application implemented in software or other program code, as described in more detail below. Host may also provide services to other computing or data processing systems or devices. For example, host may also provide transaction processing services, email services (for delivering alerts), etc.

In an exemplary embodiment, networked computer system may also include a web portal on a third-party venue (e.g., a commercial Internet site), which facilitates a connection for one or more clients with host (e.g., via a back-end link). In another exemplary embodiment, portal icons may be provided (e.g., on third-party venues, pre-installed on computer or appliance desktops, etc.) to facilitate a direct link to the host.

The term “client” as used herein refers to a computing device through which one or more users (e.g., print shop management, production operators and their managers) may access the benchmarking service. Client computing devices may include any of a wide variety of computing systems, such as a stand-alone personal desktop or laptop computer (PC), workstation, personal digital assistant (PDA), or appliance, to name only a few examples. Each of the client computing devices may include memory, storage, and a degree of data processing capability at least sufficient to manage a connection to the benchmarking application either directly via network to host or indirectly (e.g., via a network site). Client computing devices may connect to network via a communication connection, such as wired or wireless network access.

The benchmarking application may be implemented in program code which may have any suitable form, including but not limited to, computer software, web-enabled or mobile applications or “apps”, so-called “widgets,” and/or embedded code such as firmware. Although the program code may comprise a number of components or modules for purposes of illustration herein, the program code is not so limited. The program code may include additional components, modules, routines, subroutines, etc. In addition, one or more functions may be combined into a single component or module.

The benchmarking application includes a workflow component and a derivation (e.g., modeling or simulation) component. The bench marking application receives input from the workflow component. The benchmarking application may be implemented as program code stored in computer-readable storage. When executable by a processor, the program code receives a plurality of automatic print service parameters and manual print service parameters being monitored in real-time from the workflow component. The program code generates performance metrics using the derivation component for one or more PSP facility based on the received automatic and manual print service parameters. The performance metrics can then be compared to actual performance at the PSP facility, and efficiency metrics can be generated by the program code for one or more of the automatic and/or manual print production processes at the PSP facility based on the comparison.

It is noted that the terms “performance” and “performance metric” are defined as the actual production values (e.g., measured on the floor) or derived production values (e.g., using simulation). At different levels of granularity, the performance metric can be, by way of example, at the system level: throughput, end-to-end cost per page, etc.; at the machine level: utilization rate, capacity, inventory build-up, breakdown frequency, etc.; and at the labor level: time to perform a task, number of different types of works able to perform, etc.

The program code may be further executable to generate an exception when actual performance metrics are outside a predetermined range of the efficiency metrics. A user can choose from responding to the exception, ignoring the exception, and delaying the exception. The program code may be further executable to notify a user when and how to increase and decrease production at the one or more PSP facility.

The program code may be further executable to generate target production at different granularities of the one or more PSP facility. Different granularities may also be available for different access levels. For example, long term planning may be provided with an overview of production across multiple PSP facilities. Print shop management may be provided with overall production at a particular PSP facility. And operators and their respective managers may be provided with a view of production for a particular station or group of stations at the PSP facility. The program code may also be executable to generate production histories for different granularities of the one or more PSP facility, e.g., for reporting and planning.

In an exemplary embodiment, the derivation component of the benchmarking application generates various efficiency metrics, such as the maximum achievable rate of a production variable based on the actual floor conditions (e.g., number of machines online, operator efficiency). Actual production data (e.g., capacity, throughput) of an individual station or group of stations is determined (e.g., using the monitored information). This information is fed back to workflow software for visual presentation in real-time to one or more users, as discussed in more detail with reference to FIGS. 3a-b.

FIGS. 3a-b show exemplary user interface displays 350 which may be implemented for benchmarking at the PSP shown in FIG. 3, wherein (a) shows workflow for overall plant operations, and (b) shows workflow for a specific station. In the embodiment shown in FIGS. 3a-b, the user interface is displayed in a web browser (e.g., Internet Explorer, Firefox Mozilla, etc.). The web browser embodiment, however, is merely illustrative. It is noted that the input/output may be via any suitable user interface including but not limited to proprietary software executable on a desktop or laptop computer, a television display, and so forth. The browser interface enables the user to interface with the benchmarking application to input and/or retrieve information.

In an exemplary embodiment, the browser interface may be implemented as a graphical user interface (GUI) in a “windows-based” operating system environment (e.g., Microsoft Corporation's WINDOWS®), although the browser interface is not limited to use with any particular operating system. The user may launch the browser interface in a customary manner, for example, by clicking on an icon, selecting the program from a menu, or pressing a key on a keyboard.

The browser interface supports operator interaction through common techniques, such as a pointing device (e.g., mouse, style), keystroke operations, touch screen, or audio-enabled (e.g., voice command). By way of illustration, the operator may make selections using a mouse to position a graphical pointer and click on a label or button displayed in the browser interface. The operator may also make selections by entering a letter for a menu label while holding the ALT key (e.g., “ALT+letter” operation) on a keyboard. In addition, the user may use a keyboard to enter command strings (e.g., in a command window).

The browser interface is displayed for the operator in a window, referred to as the “application window” 351, as is customary in a window environment. The application window 351 may include customary window functions, such as a Minimize Window button 352, a Maximize Window button 353, and a Close Window button 354. A title bar 355 identifies the application window 351 for the user (e.g., by PSP facility name and/or station identity). The application window 351 may also include a customary menu bar 356 having an assortment of pull down menus (e.g., labeled “File,” “Edit,” “View,” “Go,” “Bookmarks,” “Tools,” and “Help”), which are well-known in commonly used browser interfaces. For example, the operator may select a print function (not shown) from the “File” menu (designated herein as “File|Print”).

Application window 351 also includes an operation space 360. Operation space 360 may include one or more graphics for displaying output and/or facilitating input from the operator. Although not shown, the graphics may also include, but are not limited to, subordinate windows, dialog boxes, icons, text boxes, buttons, and check boxes. An exemplary operation space 360 is shown in FIGS. 3a-b.

The embodiment shown in FIG. 3a is generally intended for the PSP management. A graphical representation of a production floor of the PSP facility is depicted in a first window 370 showing stations, offices, and storage space, in a graphical layout corresponding to the layout of the actual production floor. In other views that may be available to the PSP management, a graphical representation may show the entire PSP facility or multiple PSP facilities. The functional components (in this case, stations on the production floor) may be color coded. For example, the color white may represent a station that is offline, the color green may indicate that the efficiency metrics are being met, the color yellow may indicate a warning that a station is not currently meeting efficiency metrics or may soon drop below efficiency metrics, and the color red may indicate a failure or shut-down. Additionally, a component color can flash to attract the attention of the user. The operation space 360 in FIG. 3a also shows overall plant metrics, status, and current exceptions in window, e.g., in windows 371 and 372. Depending on permissions, a user can access all the data across the facility and/or at other facilities.

The embodiment shown in FIG. 3b is generally intended for the operator and/or line manager. In addition to showing a specific floor where a machine or operator is located, the operator or line manager may also be able to see how their performance compares to a target performance, and which areas might need assistance in meeting the target. Other information may also be displayed, as illustrated in windows 373 and 374. For example, a graph showing the color-coded time series of the target performance as well as the measured real-time performance can be useful in determining both the productivity over a period of time and seeing potential problematic patterns. For purposes of illustration, in FIG. 3b, the solid line indicates actual performance and the dotted line shows target performance. In general, the actual performance follows the target performance, except for a section indicated by arrow 390 where the real-time data and derived data are not correlated, indicating a potential area that needs further evaluation.

In operational efficiency improvement scenarios, such as lean manufacturing, the management and operators strive to improve the manufacturing process and actively react to the current situation. Previously this had to be done by literally looking around the PSP facility to determine the state of production and reacting retroactively to any problem spots. The benchmarking system described herein provides a simple to use and understand interface with accurate and dynamic feedback to enable performance monitoring and improvement. The system can also be used as an early warning to potential problems on the production floor. By looking at predicted and actual performance of an entire system of predicted versus measured, and the trends of deviations of the measured data and the derivation, users can determine whether certain changes are needed to be implemented in advance of a problem. For purposes of illustration, if the measured inventory build-up upstream of one machine class is significantly higher than the prediction and is growing, this may be a strong indicator that the capacity of that particular machine class is operating in a reduced capacity, which could be due to a machine failure or potential failure yet to be discovered. Corrective responses may include dispatching engineers to the floor to examine the machines, bringing reserve capacity online (such as a new machine or shifting operators from another area), or slowing down the upstream production to reduce or prevent inventory build up. The real-time feedback alerts managers and operators so that the appropriate resources can be allocated to maintain desired efficiencies and reduce or prevent the effect of problems early on.

Average, shift statistic, or target values can also be presented alongside to give a reference point of view. The employees or the management can use such a feedback to know how well they are currently performing relative to the metrics and where in the system they need to allocate more resources to eliminate potential bottleneck. Matching or exciding the metric can also provide useful information. The benchmark metric may also be based on the quality of the product. For example, faster is not necessarily better if the product needs a lot of rework. Likewise, a slow performer may be due to upstream quality issues which should be accommodated or taken into consideration.

Before continuing, it is noted that the systems and devices discussed above are merely intended to be representative of various embodiments which may be implemented for benchmarking for a PSP. Still other physical embodiments are contemplated and will become readily apparent to those having ordinary skill in the art after becoming familiar with the teachings herein based at least in part on desired implementations and the current state of the art for the various components.

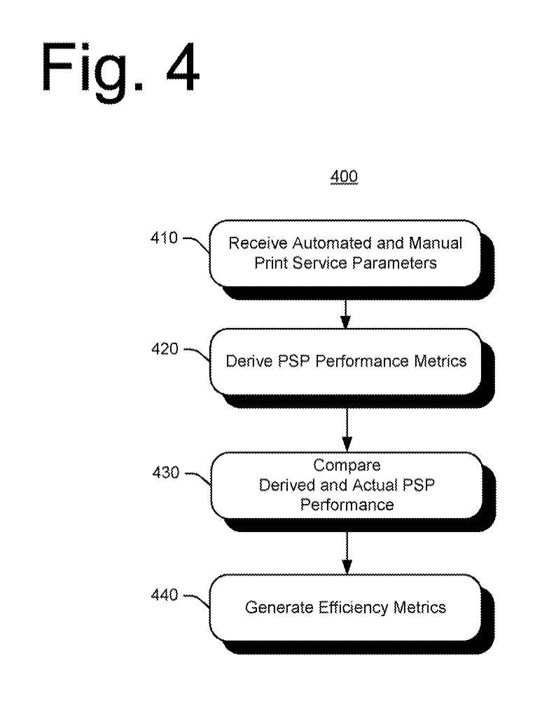

FIG. 4 is a flowchart illustrating exemplary operations which may be implemented in benchmarking for a PSP. Operations 400 may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used for brokering creative content online.

In operation 410, a plurality of automatic print service parameters and manual print service parameters are received. In one example, the parameters are received substantially in real-time (i.e., in an on-going basis as events occur). Also in an example, both the automatic and manual print service parameters are received at substantially the same time.

Automatic print service parameters may include, but are not limited to, machine status, machine throughput, machines online, machines offline, print job scheduling, pending service requests, and historical data. Manual print service parameters may include, but are not limited to, employee status, employee throughput, total employees, employee experience, employee scheduling, and historical data.

In operation 420, performance of the PSP is derived based on the automatic and manual print service parameters. For example, program code may analyze current and historical parameters according to one or more statistical models.

In operation 430, the derived performance is compared to actual performance at the PSP. In operation 440, efficiency metrics are generated for automatic and manual print production processes based on the comparison. The efficiency metrics may be generated for the user via a graphical user interface, such as the exemplary interface described above with reference to FIGS. 3a-b. In an embodiment, a time-based graph may be utilized to show performance for a window of time. The shape of the graph may also be used to monitor trends. For example, producing at a constant rate versus high variation in performance may signal that something is not going well and may malfunction if not addressed.

The operations shown and described herein are provided to illustrate exemplary implementations of benchmarking for a PSP. It is noted that the operations are not limited to the ordering shown. Still other operations may also be implemented.

For purposes of illustration, the method may also include adjusting granularity to provide efficiency metrics for one or more of individual stations at a facility, groups of stations at a facility, individual facility operations overview, and multiple facilities operations overview. The method may also include determining actual performance at the PSP based on actual performance at one or more PSP station.

It is noted that the exemplary embodiments shown and described are provided for purposes of illustration and are not intended to be limiting. Still other embodiments are also contemplated.

1. A method of benchmarking for a print service provider (PSP), comprising:
receiving a plurality of automatic print service parameters in real-time, and at substantially the same time, receiving a plurality of manual print service parameters;
deriving performance metrics of the PSP based on predictive methods using the received automatic and manual print service parameters;
comparing the derived performance metrics to actual performance at the PSP; and
generating efficiency metrics for automatic and manual print production processes based on the comparison.

2. The method of claim 1, wherein:
the plurality of automatic print service parameters include at least one of the following: machine status, machine throughput, machines online, machines offline, print job scheduling, pending service requests, and historical data; and
the plurality of manual print service parameters include at least one of the following: employee status, employee throughput, total employees, employee experience, employee scheduling, and historical data.

3. The method of claim 1, wherein deriving performance metrics is based on at least one of: modeling, simulation, inference from historical data, a knowledge base, machine learning program, and a combination thereof.

4. The method of claim 1, wherein adjusting granularity of performance metric to provide efficiency metrics for at least one of the following: individual stations at a facility, groups of stations at a facility, individual facility operations overview, and multiple facilities operations overview.

5. The method of claim 1, further comprising determining actual performance at the PSP based on actual performance at one or more PSP station.

6. A system for benchmarking a print service provider (PSP) facility, comprising:
a derivation module operatively associated with at least one automatic monitor at a plurality of stations in the PSP facility, the derivation module receiving print service parameters for automatic and manual print production processes to derive performance metrics at the PSP facility;
a comparator configured to analyze the performance metrics from the derivation module and actual performance metric at the PSP facility; and
a communications device for communicating efficiency metrics for the automatic and manual print production processes based on the analysis by the comparator.

7. The system of claim 6, further comprising a feedback loop providing the actual performance at the PSP facility to the derivation module.

8. The system of claim 6, further comprising an interface configured to receive input from a user for the derivation module to generate performance.

9. The system of claim 6, further comprising a notification device configured to alert one or more users of potential problems at the PSP facility when actual performance metrics are outside a predetermined range of the efficiency metrics.

10. The system of claim 6, further comprising a workflow layer providing at least one of the following to the derivation module: machine status, machine throughput, machines online, machines offline, print job scheduling; and pending service requests, employee status, employee throughput, total employees, employee experience, and employee scheduling.

11. The system of claim 6, further comprising a notification device configured to display a time-based graph to show performance for a window of time.

12. The system of claim 11, wherein the time-based graph shows monitored trends.

13. The system of claim 12, wherein the monitored trends include monitoring production at a constant rate versus high variation in performance.

14. A print service provider (PSP) benchmarking system including program code stored in computer-readable storage and executable by a processor to:
receive a plurality of automatic print service parameters and manual print service parameters being monitored in real-time;
deriving performance metrics of the PSP based on predictive methods using the automatic and manual print service parameters;
compare the derived performance metrics to actual performance at the one or more PSP facility; and
generate efficiency metrics for automatic and manual print production processes at the one or more PSP facility based on the comparison.

15. The system of claim 14, wherein the program code is further executable to generate an exception when actual performance metrics are outside a predetermined range of the efficiency metrics, wherein a user can choose from responding to the exception, ignoring the exception, and delaying the exception.

16. The system of claim 14, wherein the program code is further executable to generate target production at different granularities of the one or more PSP facility.

17. The system of claim 14, wherein the program code is further executable to generate production histories for different granularities of the one or more PSP facility.

18. The system of claim 14, wherein the program code is further executable to notify a user when and how to increase and decrease production at the one or more PSP facility.

19. The system of claim 14, wherein the performance metrics include prioritizing the print job.

20. The system of claim 19, wherein the priorities for the print job are the same, or different from any priorities specified by the customer.
